(19) United States
(12) Patent Application Publication
(10) Pub. No.: US 2025/0360900 A1
(43) Pub. Date: Nov. 27, 2025

(54) METHOD FOR CONTROLLING A BRAKING SYSTEM, AND BRAKING SYSTEM

(71) Applicant: Continental Automotive Technologies GmbH, Hannover (DE)

(72) Inventors: Thorsten Ullrich, Gernsheim (DE); Martin Baechle, Königstein (DE)

(73) Assignee: Continental Automotive Technologies GmbH, Hannover (DE)

(21) Appl. No.: 19/218,225

(22) Filed: May 24, 2025

(30) Foreign Application Priority Data
May 24, 2024 (DE) 10 2024 204 798.8
Sep. 26, 2024 (DE) 10 2024 209 347.5

(51) Int. Cl. B60T 13/74; B60T 7/04

(52) U.S. Cl. CPC B60T 13/741; B60T 7/042; B60T 2270/413; B60T 2270/82

(57) ABSTRACT

A brake system and method for controlling a braking system comprises transmitting pedal-sensor data to a brake control unit, calculating preprocessing data with the brake control unit, transmitting the preprocessing data to a vehicle controller, calculating control information for at least one electromechanical wheel brake from the preprocessing data in the vehicle controller, and transmitting the control information for the electromechanical wheel brake to a brake control unit. The at least one brake control unit determines whether the control information received from the vehicle controller falls below a safety threshold before forwarding the control information to the at least one electromechanical wheel brake, and, overwrites the control information before forwarding to the at least one electromechanical wheel brake when the control information is below the safety threshold.

### TECHNICAL FIELD

The embodiments relate to a method for controlling a braking system, in particular for controlling at least one electromechanical brake. Furthermore the embodiments relate to a braking system which is configured to carry out such a method.

### BACKGROUND

Electromechanical brake (EMB) system architectures which enable the realization of a two-circuit fallback level are known from German patent application 10 2023 200 166.7. The basic requirement here is the use of a redundant electronic brake pedal in which the two independent sensor paths are supplied to two likewise independent electronic control units. Two axle control units (AxCU—Axle Control Unit, i.e. control units for controlling the electromechanical wheel brakes of a vehicle axle) are proposed for processing the redundant sensor paths. These two control units process the sensor signals of the electronic brake pedal, for example by reading in sensor interfaces according to the SENT standard, perform preprocessing, monitoring and, if necessary, a plausibility check and make the signals processed in this way available on the communication bus(es). Thus, the information about the degree of actuation of the brake pedal reaches a vehicle controller which thus calculates the braking request again in the form of a braking force or a vehicle deceleration, distributes the braking forces to the four wheel brakes of the vehicle and sends corresponding setpoints to the control units of the electromechanical wheel brakes.

If the vehicle controller completely fails, at least one redundancy level is required for calculating and implementing the braking request from the driver. This is already evident from the relevant standards which prescribe a minimum deceleration capability in the event of a single fault in the braking system.

### SUMMARY

Therefore, an object is to further increase the fail-safety of the braking system, in particular in the event of malfunctions/faults in the vehicle controller which are not otherwise detected. This relates to such cases in which the vehicle controller does not fail completely, that is to say can still deliver control information but which control information is potentially erroneous. This may be caused by either hardware faults or software faults. Such partial functional failures are more difficult to detect than complete failures and are therefore not or only partially covered by previous safety measures and fallback levels.

A method for controlling a braking system, comprises transmitting pedal-sensor data to a brake control unit, calculating preprocessing data with the brake control unit, transmitting the preprocessing data to a vehicle controller, calculating control information for at least one electromechanical wheel brake from the preprocessing data in the vehicle controller, and transmitting the control information for the electromechanical wheel brake to a brake control unit. The at least one brake control unit determines whether the control information received from the vehicle controller falls below a safety threshold before forwarding the control information to the at least one electromechanical wheel brake, and, overwrites the control information before forwarding to the at least one electromechanical wheel brake when the control information is below the safety threshold. This prevents safety-relevant underbraking due to erroneous control information of the vehicle controller. At the same time, the detailed braking behavior during normal operation can be adapted by the vehicle controller of the respective automobile manufacturer and the brake control unit overwrites the control information, for example only when safety-relevant underbraking is detected. Due to the sequence of the signal forwarding and processing, the at least one brake control unit knows the pedal-sensor data and can therefore recognize, by comparing the pedal-sensor data or the preprocessing data with the control information, if a safety-relevant fault has occurred during the calculation of the control information in the vehicle controller. Thus, the method can intervene both in the event of a total failure and in the event of a temporary or continuous malfunction of the vehicle controller without the exact cause needing to be known or recognized.

The braking system comprises at least one electromechanical wheel brake but can also comprise two, three or four electromechanical wheel brakes. In the steps of the method, the control information is calculated and/or forwarded and/or overwritten for all existing wheel brakes in each case by way of the vehicle controller and/or the brake control unit(s).

The safety threshold is defined by a characteristic curve that is dependent on the pedal-sensor data, the characteristic curve being stored locally in the at least one brake control unit. The characteristic curve can be stored, for example, as a lookup table or as a functional dependency in the (or in the plurality of) brake control unit(s).

In one embodiment, the at least one brake control unit automatically calculates secondary control information from the pedal-sensor data and uses this secondary control information for overwriting the control information received from the vehicle controller if the safety threshold is fallen below. Thus, the brake control unit can react faster if the control information of the vehicle controller falls below the safety threshold, since the secondary control information has already been calculated in parallel with the vehicle controller and is available immediately without requiring further local calculation steps.

In one embodiment at least one method step is carried out in parallel in two brake control units. Alternatively, all the steps of the method relevant for the brake control unit are carried out in parallel in both brake control units but at the end only one of the brake control units transmits the unchanged or overwritten control information to the wheel brakes. This makes it possible for the brake control units to check the preprocessing data and/or the control information for plausibility with each other or, if one of the brake control units fails, to take over the other at any time.

In one embodiment, the safety threshold is determined on the basis of a deceleration characteristic curve that is dependent on pedal-sensor data, for example that is dependent on pedal force, the safety threshold lying below the deceleration characteristic curve by a constant deceleration value, e.g. between 0.4 and 0.8 standard accelerations, but with the safety threshold being at least 0 m/s². This ensures that the brake control unit does not already intervene and overwrite the control information if the control information sent from the vehicle controller to the brake control unit(s) deviates relatively little from the deceleration characteristic curve. At the same time, however, it is ensured that the brake control unit intervenes in any case if a braking request has been detected from the pedal-sensor data but the vehicle controller does not implement any deceleration in the control information (e.g. due to a software or memory fault).

The overwriting of the control information in the event that the safety threshold is fallen below may be carried out until; new control information from the vehicle controller lies above the safety threshold again, or the end of the present braking operation is detected or the start of a new braking operation is detected, or the end of the present driving cycle of the vehicle is detected or the start of a new driving cycle of the vehicle is detected. Falling below the safety threshold may be a one-off occurrence or falling below for a minimum duration after which the brake control unit overwrites the control information of the vehicle controller for the electromechanical brakes for the above-described duration (that is to say switches to an “overwriting mode”).

Overwriting of the control information before forwarding it to the electromechanical wheel brakes may only take place when the control information received from the vehicle controller continuously falls below the safety threshold for a predetermined minimum duration, e.g. between 25-250 milliseconds. By suitably selecting the minimum duration, the probability of an unwanted faulty activation of the “overwriting mode” can be reduced, since for example the brake control unit does not take over due to a single value of the control information of the vehicle controller being too low. At the same time, the minimum duration should not be selected to be too high in order to ensure that the brake control unit intervenes sufficiently quickly in the event of emergency braking and simultaneous partial failure of the vehicle controller.

The embodiments also relate to a braking system, for example for a motor vehicle, comprising a brake pedal having at least one pedal sensor for detecting a braking request from the driver by means of pedal-sensor data, at least one electromechanical wheel brake, e.g. four electromechanical wheel brakes, at least one brake control unit, e.g. two brake control units, and a vehicle controller of the motor vehicle. The brake control unit may be configured to calculate preprocessing data from the pedal-sensor data and to provide the preprocessing data to the vehicle controller via a signal link. The vehicle controller may be configured to calculate control information for at least one electromechanical wheel brake on the basis of the preprocessing data and to transmit the control information to the at least one wheel brake via at least one signal link. At least one brake control unit is configured to carry out the method. Such a braking system is protected against partial failures or malfunctions in the vehicle controller.

The braking system may comprise two brake control units which are each configured to carry out the method as described herein. This increases the fail-safety of the braking system yet further.

In one embodiment, the braking system comprises at least two primary wheel-brake modules which are designed to be arranged on a respective vehicle wheel and in each of which one of the electromechanical wheel brakes and an assigned brake control unit are integrated. The respective integration of one of the electromechanical wheel brakes and an assigned brake control unit in a primary wheel-brake module reduces the installation effort compared to separate redundant brake control units while still maintaining a high degree of fail-safety of the braking system.

The pedal sensor is connected to both brake control units via a respective separate braking-request signal line. This design allows a higher level of fail-safety to be achieved, since the at least one pedal sensor is connected to two brake control units via independent braking-request signal lines.

The terms signal line and signal link are used synonymously in this document.

In one embodiment, the brake pedal comprises at least two pedal sensors which determine different measurement variables, for example a force sensor and/or a displacement sensor and/or an angle sensor, and at least the signals of two pedal sensors which determine different measurement variables being able to be transmitted during operation to each of the brake control units. The use of pedal sensors which determine different measurement variables increases the fail-safety and, depending on the combination of the measurement data, also to some extent the accuracy of detecting the braking request.

The brake pedal comprises at least two redundant pedal sensors which determine the same measurement variable, for example two force sensors and/or two displacement sensors and/or two angle sensors, and signals from a respective redundant pedal sensor being able to be transmitted during operation to a respective brake control unit. The pedal sensors which determine the same measurement variable are preferably pedal sensors with different designs and/or differing measuring principles for the same measurement variable. The brake pedal may comprise at least four pedal sensors, at least two pedal sensors each determining the same measurement variable, that is to say, for example, two force sensors and two displacement sensors. Alternatively, two pedal sensors can also be used, each of which determines three different measurement variables, that is to say, e.g., two force sensors, two displacement sensors and two angle sensors. The signals from two (or three) pedal sensors which determine different measurement variables can then be transmitted from different pedal sensors to each of the brake control units during operation. Each brake control unit is then assigned its own set of pedal sensors which determine different measurement variables. Each of the mentioned features increases the fail-safety of the braking system.

In one embodiment, the two primary wheel-brake modules are assigned to one axle of the vehicle and at least one basic control unit is assigned to two further electromechanical wheel brakes on the other axle of the vehicle, which basic control unit is designed to receive control information and to control at least one of the two further electromechanical wheel brakes. The basic control unit(s) may not be configured to calculate preprocessing data from the pedal-sensor data. The basic control units can thus be control units with a simpler design than the brake control units.

At least one basic control unit may be able to be supplied with control information from both brake control units via separate signal lines during operation. This allows the brake control units to be connected in the signal path between the vehicle controller and the basic control units during normal operation, such that the brake control units can take over monitoring functions via the vehicle controller. Erroneous control information can thus be identified by the brake control units before it is implemented.

The braking system may comprise two secondary wheel-brake modules which are designed to be arranged on a respective vehicle wheel and in each of which a further electromechanical wheel brake and an assigned basic control unit are integrated, each of the basic control units being designed to receive control information and to control the assigned electromechanical wheel brake. A wheel brake module consisting of an electromechanical wheel brake and a wheel control unit (WCU) is then arranged on each of the vehicle wheels, this increasing the fail-safety of the braking system without significantly increasing the installation effort.

Both basic control units may be able to be supplied with control information from both brake control units via separate signal lines during operation. If one of the signal lines fails, the brake control unit connected to the other signal line can thus take over the transmission of control information to both basic control units (and optionally the other brake control unit or its assigned wheel brake).

The vehicle controller may be configured to transmit the control information for at least one electromechanical wheel brake to the brake control unit via a signal line, for example two brake control units via two separate signal lines, the brake control unit being configured to forward the control information to at least one electromechanical wheel brake, for example to four electromechanical wheel brakes. By virtue of this type of signal distribution of the control information, the at least one brake control unit can check all the control information of the vehicle controller for one or more (e.g. four) wheel brakes before it is implemented. This allows malfunctions, software faults and partial failures of the vehicle controller, which could otherwise lead to a faulty braking operation, to be detected. Previous security measures and fallback levels are usually focused on total failures of hardware which are more easily automatically recognizable but, due to the increasing software control of the vehicles, security measures against software malfunctions are becoming increasingly important.

Further details are evident from the description of the illustrated exemplary embodiments and the attached claims.

### BRIEF DESCRIPTION OF THE DRAWINGS

FIGS. 1 and 2 show braking systems having a basic control unit,

FIGS. 3 and 4 show braking systems having two secondary wheel-brake modules,

FIG. 5 shows a flowchart of a method, and

FIG. 6 shows a possible characteristic curve that is dependent on the pedal-sensor data.

### DETAILED DESCRIPTION

In the detailed description of embodiments below, the same reference signs denote substantially identical or identical parts in or on these embodiments. However, for better clarification, the embodiments illustrated in the figures are not always illustrated to scale.

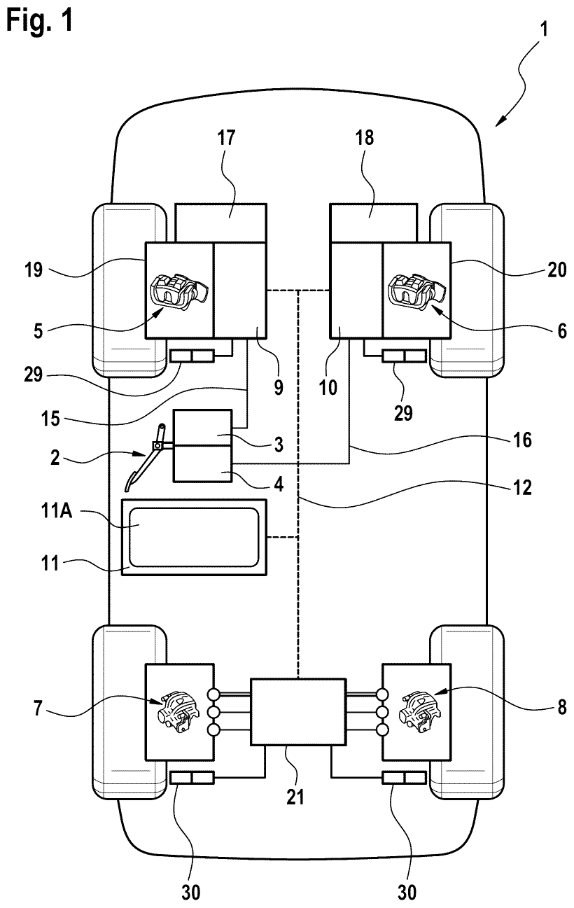

FIGS. 1 to 4 show embodiments of braking systems 1 for a motor vehicle, comprising a brake pedal 2 having at least two pedal sensors 3, 4 for detecting a braking request from the driver by means of pedal-sensor data. Furthermore, the braking system 1 comprises four electromechanical wheel brakes 5, 6, 7, 8 and two brake control units 9, 10.

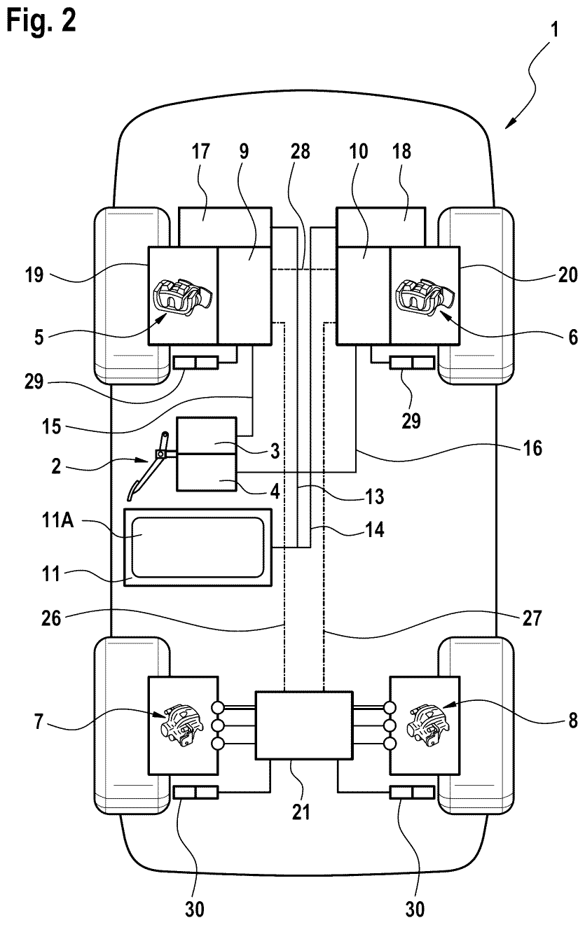

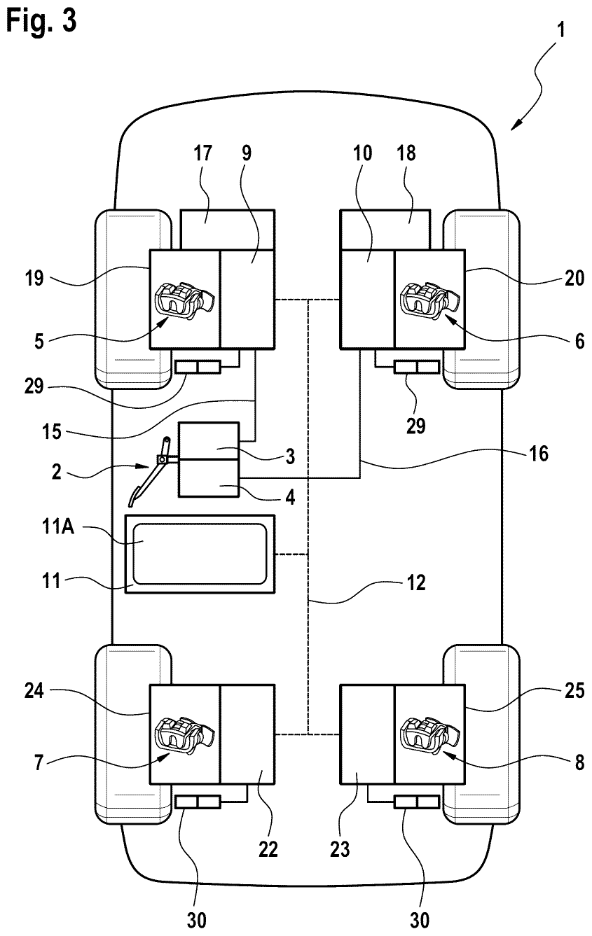

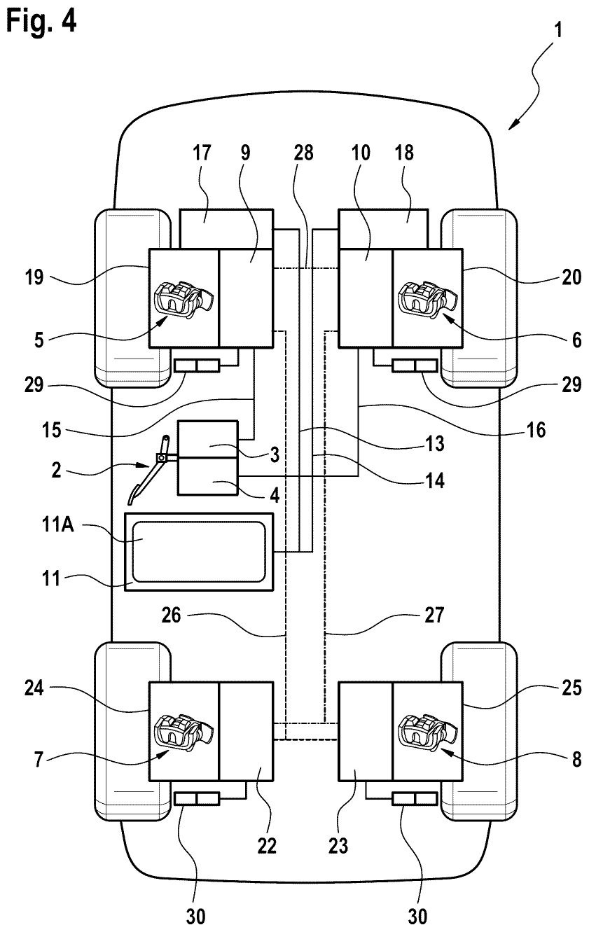

Each brake control unit 9, 10 is configured to calculate preprocessing data from the pedal-sensor data and to provide the preprocessing data to a vehicle controller 11 via a signal link 12, 13, 14. The signal link 12 may be a vehicle bus (e.g. CAN bus) (see FIGS. 1 and 3) or the signal links 13, 14 between the vehicle controller 11 and the brake control units 9, 10 may be separate signal lines (see FIGS. 2 and 4). The vehicle controller 11 may be configured, inter alia, to execute vehicle chassis functions 11A (such as, e.g., control functions for the braking system 1), this being done via suitably configured software.

The pedal sensors 3, 4 are connected to both brake control units 9, 10 via a respective separate braking-request signal line 15, 16.

The vehicle controller 11 is configured to calculate control information for all electromechanical wheel brakes 5, 6, 7, 8 on the basis of the preprocessing data and to transmit the control information to the wheel brakes via at least one signal link 12, 13, 14. The brake control units 9, 10 are each assigned to a brake circuit 17, 18 and can automatically supply all the electromechanical wheel brakes 5, 6, 7, 8 with control information in the event of failure of the vehicle controller 11 and/or of the respective other brake control unit 9, 10.

Each of the brake control units 9, 10 is configured to forward control information (from the vehicle controller 11 or in the fallback level of its own) to the four electromechanical wheel brakes 5, 6, 7, 8.

The braking system architecture proposed is therefore suitable for realizing a two-circuit fallback level (via the brake circuits 17, 18). What is to be understood by this is that both brake control units 9, 10 which process the sensor data of the electronic brake pedal 2 not only have sensor signal preprocessing but also have their own detection of the braking request and can also perform a (usually conservative, i.e. stable) brake force distribution. There is thus a doubly redundant path for controlling the electromechanical wheel brakes 5, 6, 7, 8. These redundant paths can be brought into effect in the event of detected faults, for example the failure of the vehicle controller 11, an on-board electrical system or one of the brake control units 9, 10 of the electromechanical wheel brakes 5, 6, 7, 8.

It is proposed to connect the redundant sensor paths (in particular via the separate braking-request signal lines 15, 16) of the electronic brake pedal 2 to the two independent brake control units 9, 10 of the electromechanical wheel brakes 5, 6, 7, 8, in particular of one axle, for example the front axle. Connecting the brake pedal 2 to wheel control units of the electromechanical wheel brakes 7, 8 of the rear axle is not shown but also possible.

A diagonal distribution, i.e. connecting one of the two redundant sensor paths of the electronic brake pedal 2 to a brake control unit of the front axle and the other sensor path to a brake control unit of the rear axle, would also be possible. However, connecting to the brake control units 9, 10 of the electromechanical wheel brakes 5, 6 of the front axles may keep the cable lengths for the connection of the sensor paths of the electronic brake pedal 2 as short as possible.

In all the embodiments, provision is made for the two brake control units 9, 10, which are used in particular for connecting the redundant sensor paths, to be supplied by different (independent) on-board electrical systems.

Accordingly, the braking system 1 comprises two primary wheel-brake modules 19, 20 which are designed to be arranged on a respective vehicle wheel and in each of which one of the electromechanical wheel brakes 5, 6 and an assigned brake control unit 9, 10 are integrated. The two primary wheel-brake modules 19, 20 are assigned to one axle of the vehicle. At least one basic control unit 21, 22, 23 is assigned to the two further electromechanical wheel brakes 7, 8 on the other axle of the vehicle, which basic control unit is designed to receive control information and to control at least one of the two further electromechanical wheel brakes 7, 8.

A basic control unit 21 may be provided for two electromechanical wheel brakes 7, 8 of the same axle of the vehicle (FIGS. 1 and 2). However, each of the electromechanical wheel brakes 7, 8 may also be provided with its own basic control unit 22, 23 (see FIGS. 3 and 4).

In the embodiments of FIGS. 3 and 4, the braking system comprises two secondary wheel-brake modules 24, 25 which are designed to be arranged on a respective vehicle wheel and in each of which one of the two further electromechanical wheel brakes 7, 8 and an assigned basic control unit 22, 23 are integrated.

Each basic control unit 21, 22, 23 is able to be supplied with control information from both brake control units 9, 10 via at least one signal line 12, 26, 27 during operation. This signal line 12 may be a system bus as in FIGS. 1 and 3 or provision may be made for a respective separate signal line 26, 27 from each of the brake control units 9, 10 to each of the two basic control units 22, 23 as in FIGS. 2 and 4.

The primary wheel-brake modules 19, 20 and the brake control units 9, 10 are either connected via a signal link 12 in the form of a system bus as, e.g., in FIGS. 1 and 3 or provision is made for a separate signal link 28 as, e.g., in FIGS. 2 and 4.

A respective rotational speed sensor 29 of the associated vehicle wheel is connected to each brake control unit 9, 10 in order to deliver rotational speed data. One (FIGS. 1 and 2) or two (FIGS. 3 and 4) rotational speed sensors 30 of the associated vehicle wheel or of the associated vehicle wheels are connected to each basic control unit 21, 22, 23 in order to deliver rotational speed data.

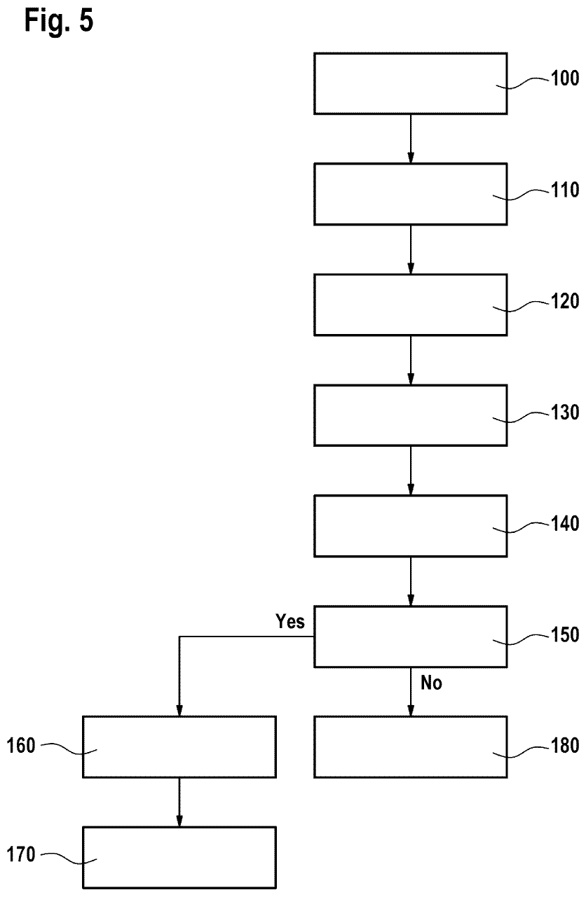

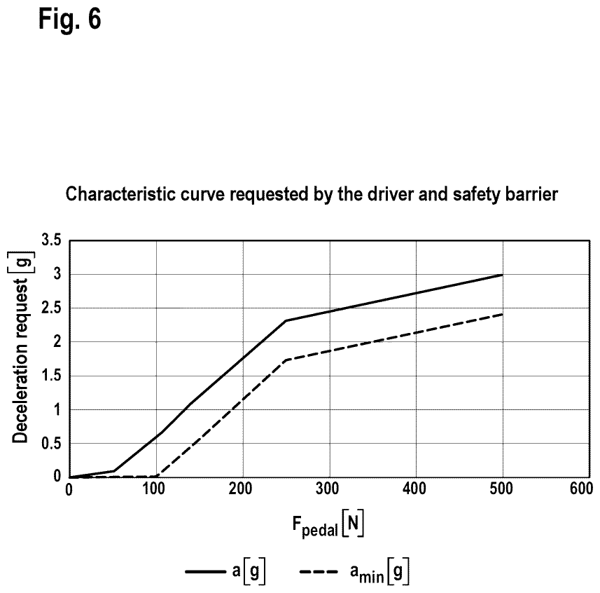

At least one brake control unit 9, 10 is configured to check the control information for the electromechanical wheel brakes 5, 6, 7, 8 that is received from the vehicle controller 11 before forwarding it and to overwrite it if a safety threshold is fallen below. This is now described in the context of the method according to the invention with reference to FIGS. 5 and 6.

FIG. 5 shows a flowchart of the method. First, a step 100 of transmitting pedal-sensor data, which are indicative of pedal actuation of the brake pedal 2, from pedal sensors 3, 4 to at least one of the brake control units 9, 10 takes place. Then, a step 110 of calculating preprocessing data is performed by way of at least one of the brake control units 9, 10. In a step 120, the preprocessing data are transmitted by way of at least one of the brake control units 9, 10 to the vehicle controller 11 via a signal link 12, 13, 14. Step 130 comprises calculating control information for at least one (e.g for four) electromechanical wheel brake 5, 6, 7, 8 from the preprocessing data in the vehicle controller 11. In step 140, the control information for at least one (e.g. for all) electromechanical wheel brake 5, 6, 7, 8 is transmitted to at least one brake control unit 9, 10 (that is to say not directly to the electromechanical wheel brake(s) 5, 6, 7, 8). Step 150 comprises determining, by way of at least one brake control unit 9, 10, before forwarding the control information to the electromechanical wheel brake(s) 5, 6, 7, 8, whether the control information received from the vehicle controller 11 falls below a safety threshold, and, if so, in step 160 the control information is overwritten before being forwarded to the electromechanical wheel brake(s) 5, 6, 7, 8 in step 170. If it is determined in step 150 that the control information received from the vehicle controller 11 does not fall below the safety threshold (“No” in the flowchart), the control information received from the vehicle controller 11 is forwarded to the electromechanical wheel brake(s) 5, 6, 7, 8 unchanged in step 180.

The brake control unit(s) 9, 10 can automatically calculate secondary control information from the pedal-sensor data and use this secondary control information for overwriting the control information received from the vehicle controller 11 if the safety threshold is fallen below. Thus, the brake control unit(s) 9, 10 can react faster if the control information of the vehicle controller 11 falls below the safety threshold, since the secondary control information can already be calculated in parallel with the vehicle controller 11 and is available immediately without requiring further local calculation steps. The secondary control information may be thus calculated, for example, in parallel with one or more of steps 110, 120, 130 or 140 by at least one brake control unit 9, 10.

The safety threshold can be defined by a characteristic curve that is dependent on the pedal-sensor data, as illustrated by way of example in FIG. 6. The characteristic curve can be stored locally in the at least one brake control unit 9, 10. The safety threshold aₘᵢₙ can be determined on the basis of a deceleration characteristic curve that is dependent on pedal-sensor data, for example that is dependent on pedal force. A deceleration characteristic curve a (solid line) that is dependent on pedal force is plotted by way of example in FIG. 6. The deceleration request (or braking request), that is to say the requested deceleration in units of normal acceleration (g=9.80665 m/s²), is plotted against the pedal force in Newtons. The pedal force may be a pedal force that is measured directly or a pedal force that is obtained by calculating various sensor data (force sensor and/or angle sensor and/or displacement sensor). The safety threshold aₘᵢₙ (dashed line) lies below the deceleration characteristic curve a by a constant deceleration value, e.g. between 0.4 and 0.8 (here 0.6) standard accelerations. However, the safety threshold aₘᵢₙ is always at least 0 m/s², that is to say is non-negative. This configuration ensures that the brake control unit 9, 10 does not already intervene and overwrite the control information if the control information sent from the vehicle controller 11 to the brake control unit 9, 10 deviates relatively little from the deceleration characteristic curve a. At the same time, however, it is ensured that the brake control unit 9, 10 intervenes in any case if a deceleration request has been detected from the pedal-sensor data but the vehicle controller 11 does not implement any deceleration in the control information (e.g. due to a software or memory fault).

In addition, it is thus also possible to implement a safety threshold on the brake control units 9, 10. The safety threshold intervenes in the event of undetected faults in the vehicle controller. For this purpose, each of the brake control units 9, 10 checks whether the setpoint values sent from the vehicle controller 11 to the electromechanical wheel brakes 5, 6, 7, 8 can cause a plausible total deceleration of the vehicle according to the braking request locally calculated on the respective brake control units 9, 10. If this is not the case, the brake control units 9, 10 can overrule the braking request formed by the vehicle controller 11 and thus increase the safety against underbraking of the vehicle.

The safety threshold aₘᵢₙ that is to be provided redundantly on the brake control units 9, 10 can be given the following features:

The safety threshold aₘᵢₙ should take effect (i.e. overrule the externally sent deceleration request) if this externally sent deceleration request falls below a minimum value.

This minimum value should be dependent on the force that the driver exerts on the brake pedal 2. This does not necessarily require direct measurement of this force. An estimate based on the sensor signals of the electronic brake pedal 2, for example based on the measured pedal-actuation travel and knowing the force-travel characteristics of the electronic brake pedal 2, can replace the direct force measurement.

A characteristic curve a (F_{pedal}) of the deceleration request that is dependent on the measured or estimated force is stored on the brake control units 9, 10 (solid line in FIG. 6).

This characteristic curve runs very flat in the range of low forces so that good controllability of the braking effect is given. In the event of an ergonomically meaningful force (which is significantly lower than the force permitted for the design of fallback levels of 500 N according to ECE R13H), the deceleration request should be about 1 g, so that full braking can be effected on normal ground (dry road). If the pedal force is increased further, the deceleration request is increased to 2 . . . 3 g. Although this deceleration is not physically able to be implemented, it does mean that the braking forces can be increased to such an extent that even if the wheel brakes 5, 6, 7, 8 are in a poor condition (for instance due to corrosion or fading), virtually full braking is always still achievable.

The safety threshold aₘᵢₙ (F_{pedal}) (dashed lines in FIG. 6) is distinguished in that the minimum value (i.e. the activation threshold of the safety threshold aₘᵢₙ) is at a constant distance below the above-described characteristic curve of the deceleration request. If this distance is referred to as aₜₒₗ, then aₘᵢₙ (F_{pedal})=MAX (0, a (F_{pedal})−aₜₒₗ) applies.

In this case, the parameter aₜₒₗ can be selected such that with the ergonomically reasonable pedal force, which results in full braking when the system is operating normally, sufficient braking effect is still achieved for most traffic situations. For example, the design of the parameter may have the aim of achieving the so-called service braking effect according to ECE R13H (6.43 m/s²).

In this case, the parameter aₜₒₗ can be selected such that robustness against faulty activations of the safety threshold is given.

In this case, it can be taken into account that the characteristic curve stored in the vehicle controller 11 can deviate by a certain amount from the characteristic curve used to determine the safety threshold value in the context of the vehicle application.

In this case, it can be taken into account that the vehicle controller 11 implements the deceleration requested by the driver to a certain extent with the drive system (for example in the case of regenerative braking).

In this case, it can be taken into account that in order to achieve further robustness against faulty activations of the safety threshold in the event of short-term overruling of the externally sent braking request from the driver by the characteristic curve stored in the brake control units, it may be advantageous to additionally link the activation of the safety threshold aₘᵢₙ to a time condition.

If the safety threshold is activated, i.e. if the externally sent braking request from the driver lies below the limit aₘᵢₙ(F_{pedal}), the brake control units implement the locally calculated braking request from the driver a(F_{pedal}) instead.

It should be noted in an application-specific manner whether the switch-back to the externally sent braking request from the driver is to be performed as soon as it exceeds the value of the safety threshold again, at the start of the next braking operation, or at the start of the next driving cycle.

In any case, when activating the safety threshold corresponding information may be stored in the non-volatile memory of the control units in order to support subsequent fault analysis.

1. A method for controlling a braking system comprising:
transmitting pedal-sensor data indicative of pedal actuation of an electronic brake pedal from at least one pedal sensor of the brake pedal to at least one brake control unit;
calculating preprocessing data with the at least one brake control unit,
transmitting the preprocessing data with the at least one brake control unit to a vehicle controller of a motor vehicle via a signal link,
calculating control information for at least one electromechanical wheel brake from the preprocessing data in the vehicle controller;
transmitting the control information for the at least one electromechanical wheel brake to at least one brake control unit;
determining with the at least one brake control unit whether the control information received from the vehicle controller falls below a safety threshold before forwarding the control information to the at least one electromechanical wheel brake; and
overwriting the control information before forwarding it to the at least one electromechanical wheel brake when the control information is below the safety threshold.

2. The method as claimed in claim 1, wherein the safety threshold is defined by a characteristic curve that is dependent on the pedal-sensor data, the characteristic curve being stored locally in the at least one brake control unit.

3. The method as claimed claim 2, wherein the deceleration characteristic curve is dependent on pedal force, and wherein the safety threshold lies below the deceleration characteristic curve by a constant deceleration value.

4. The method as claimed in claim 1, further comprising:
automatically calculating secondary control information from the pedal-sensor data with the at least one brake control unit; and
using this secondary control information for overwriting the control information received from the vehicle controller when control information is below the safety threshold.

5. The method as claimed in claim 1, wherein the at least one brake control unit is two brake control unit and at least one method step is carried out in parallel in the two brake control units.

6. The method as claimed in claim 1, wherein the overwriting of the control information further comprises the overwriting being carried out until one of:
new control information from the vehicle controller is above the safety threshold;
one of an end of a present braking operation is detected and a start of a new braking operation is detected; and
one of an end of a present driving cycle of the vehicle is detected and a start of a new driving cycle of the vehicle is detected.

7. The method as claimed in claim 1, wherein the overwriting of the control information only when the control information received from the vehicle controller continuously falls below the safety threshold for a predetermined minimum duration.

8. A braking system for a motor vehicle comprising:
a brake pedal having at least one pedal sensor for detecting a braking request from the driver by means of pedal-sensor data;
at least one electromechanical wheel brake;
at least one brake control unit configured to calculate preprocessing data from the pedal-sensor data; and
a vehicle controller of the motor vehicle which receives the preprocessing data from the at least one brake control unit via a signal link and is configured to calculate control information for at least one electromechanical wheel brake on the basis of the preprocessing data and to transmit the control information to the at least one wheel brake via at least one signal link;
wherein at least one brake control unit is configured to determine whether the control information received from the vehicle controller falls below a safety threshold before forwarding the control information to the at least one electromechanical wheel brake; and to overwrite the control information before forwarding it to the at least one electromechanical wheel brake when the control information is below the safety threshold.

9. The braking system as claimed in claim 8, wherein the braking system comprises at least two brake control units which are each configured to determine whether the control information received from the vehicle controller falls below the safety threshold and to overwrite the control information when the control information is below the safety threshold.

10. The braking system as claimed in claim 9, wherein the pedal sensor is connected to both brake control units via a respective separate braking-request signal line.

11. The braking system as claimed in claim 8, further comprising two primary wheel-brake modules which are designed to be arranged on a respective vehicle wheel and in each of which one of the electromechanical wheel brakes and an assigned brake control unit are integrated.

12. The braking system as claimed claim 8, wherein the brake pedal comprises at least two pedal sensors which determine two different measurement variables to be transmitted during operation to each of the brake control units.

13. The braking system as claimed claim 12, wherein the at least two pedal sensors are one of a force sensor, a displacement sensor, and an angle sensor.

14. The braking system as claimed in 9, wherein the brake pedal comprises at least two redundant pedal sensors which determine the same measurement variable to be transmitted during operation to a respective brake control unit.

15. The braking system as claimed in one of claim 14, wherein the at least two redundant pedal sensors are one of two force sensors, two displacement sensors, and two angle sensors.

16. The braking system as claimed in claim 11, wherein two primary wheel-brake modules are assigned to one axle of the vehicle and at least one basic control unit is assigned to two further electromechanical wheel brakes on the other axle of the vehicle, which basic control unit is designed to receive control information and to control at least one of the two further electromechanical wheel brakes.

17. The braking system as claimed in claim 14, wherein the at least one basic control unit is supplied with control information from both brake control units via separate signal lines during operation.

18. The braking system as claimed in claim 16, wherein the braking system comprises two secondary wheel-brake modules which are designed to be arranged on a respective vehicle wheel and in each of which one of the two further electromechanical wheel brakes and an assigned basic control unit are integrated, each of the basic control units being designed to receive control information and to control the assigned electromechanical wheel brake.

19. The braking system as claimed in claim 18, wherein both basic control units are supplied with control information from both brake control units via separate signal lines during operation.

20. The braking system as claimed in claim 8, wherein the vehicle controller is configured to transmit the control information for at least one electromechanical wheel brake to the brake control unit via a signal line, the brake control unit being configured to forward the control information to the at least one electromechanical wheel brake.
